(19) United States
(12) Patent Application Publication
(10) Pub. No.: US 2017/0034311 A1
(43) Pub. Date: Feb. 2, 2017

(54) Method for selecting between multiple RPC frameworks during a TCP/IP session

(71) Applicant: NetApp, Inc., Sunnyvale, CA (US)

(72) Inventors: Subin Govind, Sunnyvale, CA (US); Sunny Kalra, Santa Clara, CA (US)

(21) Appl. No.: 14/814,450

(22) Filed: Jul. 30, 2015

(51) Int. Cl. H04L 29/06

(52) U.S. Cl. CPC H04L 67/40; H04L 67/42

(57) ABSTRACT

Systems, devices, methods and computer program products are provided for selecting between multiple remote procedure call (RPC) frameworks in a client/server Transmission Control Protocol/Internet Protocol (TCP/IP) session. A server device can be configured with multiple RPC frameworks for processing and decoding RPC related communication from a client device. Each RPC framework can be designed to process RPC messages associated with a particular RPC suite. The appropriate RPC framework to decode and process incoming RPC messages can be selected based on a variety of factors. For example, the appropriate RPC framework can be selected based on the RPC suite identified by the client device during an RPC bind operation. The appropriate RPC framework can also be selected based on a server message block (SMB) pipe opened by the client device. The appropriate RPC framework can be further selected based on a client identifier.

### TECHNICAL FIELD

The present disclosure relates generally to network protocols and more specifically to a technique for enabling a server device to select between multiple remote procedure call (RPC) frameworks for decoding RPC messages during a Transmission Control Protocol/Internet Protocol (TCP/IP) session.

### BACKGROUND

Remote procedure call (RPC) is an inter-process communication mechanism between computer devices that allows an underlying operating system or other application on a client device to send messages via Transmission Control Protocol/Internet Protocol (TCP/IP) for executing processes on a server device. In an RPC architecture, procedures/messages that a client device can communicate to a server device may be bundled together as one or more RPC suites (also known as RPC services). Messages associated with an RPC suite/RPC service can be encoded and decoded by an implementation of an RPC framework executing on the server device. However, different RPC suites may have different requirements specifying how the RPC framework encodes and decodes messages to the server device.

In order to implement a new RPC suite, significant changes are required to the underlying RPC framework in the server device to meet the scalability and functionality requirements of the new RPC suite. Significant modifications to the underlying RPC framework may destabilize the entire RPC operation between the client device and the server device and introduce errors in the inter-process communication. It is therefore desirable to have a new method and system that allows the addition of new RPC suites in a client-server system without requiring modification of the underlying RPC framework and without causing disruption to the execution of existing RPC suites.

### SUMMARY

Systems and methods are described for enabling a server device to select between multiple remote procedure call (RPC) frameworks for decoding RPC communication in a client/server Transmission Control Protocol/Internet Protocol (TCP/IP) session. The server device can be configured to include multiple RPC frameworks, each designed for processing RPC messages associated with a respective set of RPC suites. Selecting between multiple RPC frameworks can be achieved by determining the appropriate RPC framework to use during an RPC bind operation or a server message block (SMB) pipe open operation. A configuration file or a configuration parameter stored in the memory of the server device can include information associating each RPC framework to an SMB pipe, an RPC suite, or a particular client identifier.

For example, in one embodiment, a method is provided for enabling a server device to select between multiple RPC frameworks for executing an RPC call request. The method can include receiving, at a server device, a request to open a first server message block pipe of a plurality of server message block pipes, where each of the server message block pipes is associated with a different plurality of remote procedure call suites. The method can also include receiving, at the server device, a request to bind to a first remote procedure call suite from the plurality of remote procedure call suites associated with the first server message block pipe. The method can further include selecting an appropriate remote procedure call framework of a plurality of remote procedure call frameworks to decode incoming remote procedure call requests that are associated with the first remote procedure call suite. The method can also include receiving, at the server device, a remote procedure call request from a client device for execution of program code at the server device. The remote procedure call request includes an identifier, such as an OpNum identifier, that identifies the program code to be executed. Further, the remote procedure call request is associated with the first remote procedure call suite. The method can further include executing the remote procedure call request using the selected remote procedure call framework.

In another embodiment, a server device is provided. The server device can be configured to select between multiple RPC frameworks for executing an RPC call request. The server device can include a processor device and a memory device including program code stored thereon. The program code, upon execution by the processor device, can perform certain operations. For example, the program code, upon execution, can perform the operation of monitoring for a request to open a first server message block pipe of a plurality of server message block pipes, where each of the server message block pipes is associated with a plurality of remote procedure call suites. The program code, upon execution, can also perform the operation of monitoring for a request to bind to a first remote procedure call suite from the plurality of remote procedure call suites associated with the first server message block pipe. Further, the program code can perform the operation of selecting an appropriate remote procedure call framework of a plurality of remote procedure call frameworks to decode a subsequent remote procedure call request that is associated with the first remote procedure call suite, where the remote procedure call request identifies program code for execution at the server device.

In another embodiment, a non-transitory computer-readable medium having program code stored thereon is provided. Upon execution, the program code performs certain operations for selecting between multiple RPC frameworks for executing an RPC call request. For example, the program code can perform the operation of monitoring for a request to open a first server message block pipe of a plurality of server message block pipes where each of the server message block pipes is associated with a plurality of remote procedure call suites. The program code can also perform the operation of monitoring for a request to bind to a first remote procedure call suite from the plurality of remote procedure call suites associated with the first server message block pipe. Further, the program code can perform the operation of selecting an appropriate remote procedure call framework of a plurality of remote procedure call frameworks to decode a subsequent remote procedure call request that is associated with the first remote procedure call suite, where the remote procedure call request identifies program code for execution at the server device.

These illustrative examples are mentioned not to limit or define the disclosure, but to provide examples to aid understanding thereof. Additional aspects and examples are discussed in the Detailed Description, and further description is provided there.

### BRIEF DESCRIPTION OF THE DRAWINGS

FIG. 1 is a block diagram illustrating a client/server system according to certain exemplary embodiments, where one of multiple RPC frameworks is selected based on the SMB pipe that is opened.

FIG. 2. is a block diagram illustrating a client/server system according to certain exemplary embodiments, where one of multiple RPC frameworks is selected based on the RPC suite that is bound.

FIG. 3 is a block diagram illustrating a client/server system according to certain exemplary embodiments, where one of multiple RPC frameworks is selected based on a client identifier.

FIG. 4 is a flowchart depicting an example of a process for selecting between multiple RPC frameworks in a client/server MS-RPC session, according to certain exemplary embodiments.

FIG. 5 is a flowchart depicting an example of a process executed by a framework selection code for selecting between multiple RPC frameworks in a client/server MS-RPC session based on the SMB pipe that is opened, according to certain exemplary embodiments.

FIG. 6 is a flowchart depicting an example of a process executed by a framework selection code for selecting between multiple RPC frameworks in a client/server MS-RPC session based on the RPC suite that is bound, according to certain exemplary embodiments.

FIG. 7 is a flowchart depicting an example of a process executed by a framework selection code for selecting between multiple RPC frameworks in a client/server MS-RPC session based on a client identifier, according to certain exemplary embodiments.

FIG. 8 is a block diagram illustrating the client/server system of FIGS. 1-3, showing further components for performing the steps disclosed herein, according to certain exemplary embodiments.

### DETAILED DESCRIPTION

In certain embodiments, the present invention provides systems and methods for enabling a service device to select between multiple remote procedure call (RPC) frameworks for decoding RPC messages received from a client device for executing processes on a server device. The server device can be configured to support multiple RPC frameworks and to determine the appropriate RPC framework to use for processing RPC messages received from a client device. For example, the memory of the server device may store two or more different versions of the same RPC framework, or two or more different RPC frameworks. In response to receiving RPC messages from a client device, the server device can determine which RPC framework to use based on a variety of factors. For example, the server device can route all RPC messages associated with a particular RPC suite to a particular RPC framework. Alternatively, the server device can route all RPC messages associated with a particular server message block (SMB) pipe to a particular RPC framework. In other aspects, the server device can route all RPC messages to a particular RPC framework based on a client identifier, so that all RPC messages from a particular client are processed by the particular RPC framework. The information used by the server device to determine which RPC framework should be selected to process incoming RPC messages can be stored in a configuration file or a configuration parameter in the memory of the server device.

The systems and methods disclosed herein for enabling a server device to select between multiple RPC frameworks can be implemented within different RPC architectures. For example, aspects disclosed herein can be implemented in a standard RPC architecture over Transmission Internet Protocol/Internet Protocol (TCP/IP). In a standard RPC over TCP/IP architecture, a client device can initiate a TCP/IP session with a server device. The client device can issue a bind request to a particular RPC suite available on the server device by sending the RPC bind request to the TCP/IP port. Each RPC suite available on the server device may include a context identifier identifying the RPC suite. The context identifier can indicate, to the server device, the possible RPC messages that may be called by the client device. During execution of the bind operation, the server device can determine, via information stored in a configuration file, which one of multiple available RPC frameworks to use to process subsequent RPC messages.

Once bound to the RPC suite, the client device may transmit RPC messages to the server device. Each RPC message includes an identifier identifying a specific procedure within the bound RPC suite. The RPC message identifier will be referred to herein as the OpNum identifier for the RPC message. The server device can execute the procedure identified by the RPC message OpNum. The RPC framework, selected by the server device as discussed above, is used to decode the received RPC message. As used herein, the term “RPC message” is intended to refer to any RPC related request, message, function or procedure call, command, or other signal communicated between a client device and a server device for executing program code in the memory of the server device. For example, an RPC message includes an OpNum identifier that can refer to the function signature of a particular procedure for execution in an underlying operating system or other application running on the server device. An RPC message can also include the input parameters for the procedure call and the output parameters that may carry the output of the procedure call for transmission back to the client device. An RPC message can also include a query to the server device, requesting administrative information or other information about the server device.

In some aspects, the systems and methods disclosed herein can be implemented in a Microsoft-RPC (MS-RPC) inter-process communication model. In MS-RPC, once a TCP/IP session is established between a client device and a server device, the client device sends a request to open a Common Internet File System (CIFS) session (also known as a Server Message block (SMB) session) with the server device. A CIFS or SMB session as used herein refers to a communication session that allows remote sharing of computer resources (e.g., file and printer access) over TCP/IP. During a CIFS session, the client device can send a request to the server device to open an SMB named pipe. An SMB named pipe refers to a logical connection between the client device and the server device for communication through the CIFS/SMB connection. Multiple SMB named pipes can be included in the server device, with each SMB named pipe providing access to one or more RPC suites. Once an SMB named pipe is open, the client device can bind to a particular RPC suite associated with the opened SMB named pipe in the manner described above for standard RPC over TCP/IP.

In an embodiment of the invention employing an MS-RPC model, the server device can be configured to determine which of multiple available RPC frameworks to use to process incoming RPC messages based on different factors. In one aspect, for example, the server device can be configured to determine which one of the multiple available RPC frameworks to use for processing subsequent RPC messages based on the SMB named pipe opened by the client device. Each SMB named pipe can be associated with the operation of a different RPC framework. Thus, the server device may process incoming RPC messages using the RPC framework associated with the SMB named pipe that is open. Alternatively, the server device can be configured to determine which one of the multiple RPC frameworks to use based on the bound RPC suite. In yet another example, the server device can be configured to determine which one of the multiple RPC frameworks to use based on the client identifier. As mentioned above, RPC messages associated with one set of RPC suites may be processed and decoded by a first RPC framework but may not be correctly processed and decoded by a second RPC framework. For example, certain RPC messages may be supported by a more recent version of an RPC framework, but not by an older version of the RPC framework. By enabling a server device to simultaneously support and select between multiple RPC frameworks for handling difference RPC messages, embodiments of the invention described herein can allow a network administrator to upgrade RPC frameworks to support new RPC suites incrementally without causing disruptions to existing client devices.

Detailed descriptions of certain embodiments are discussed below. The illustrative examples provided above are given to introduce the general subject matter discussed herein and are not intended to limit the scope of the disclosed concepts. The following sections describe various additional aspects and examples with reference to the drawings in which like numerals indicate like elements, and directional descriptions are used to describe the illustrative examples but, like the illustrative examples, should not be used to limit the present disclosure. For convenience, the following embodiments are described in the context of an MS-RPC model. However, the invention is not intended to be limited to that context and those skilled in the art will recognize that the principles of the invention may be applied in the context of other RPC models as well.

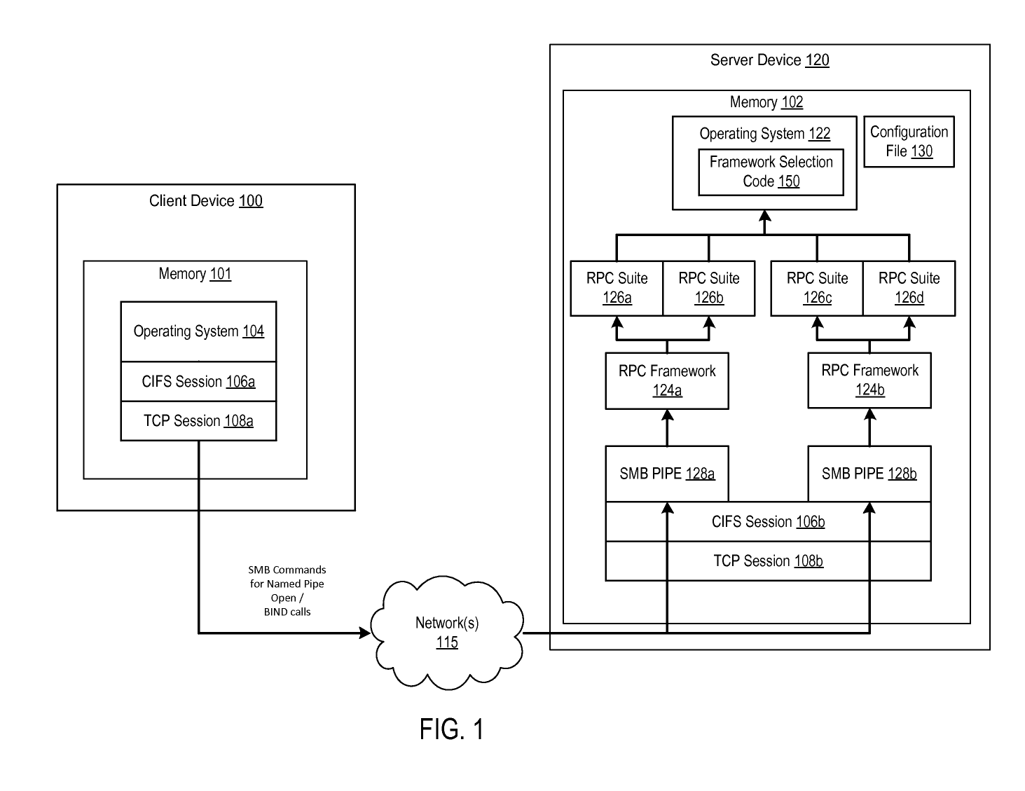

Referring now to the drawings, FIGS. 1-3 are block diagrams illustrating examples of client/server systems communicating via MS-RPC and utilizing multiple RPC frameworks. Each of the figures depicts a different aspect of how a server device may be configured to filter RPC messages to the appropriate RPC framework. For example, FIG. 1 is a block diagram illustrating a client/server system where one of multiple RPC frameworks is selected based on the SMB pipe that is opened. The system includes a client device 100 that includes a memory device 101. The system also includes a server device 120 that includes a memory device 102. Memory device 101 and memory device 102 can each include non-transitory computer-readable media suitable for storing and executing program code and other data. The client device 100 and the server device 120 communicate with each other via one or more signals communicated over one or more network(s) 115.

A processor in the client device 100 can execute an operating system 104 or other application stored in the memory device 101 that includes program code for initiating an MS-RPC session and transmitting RPC messages to the server device 120. Similarly, a processor in the server device 120 can execute an operating system 122 or other application stored in its memory device 102 that includes program code for establishing an MS-RPC session and handling and responding to RPC messages. The operating system 122 can include framework selection code 150, which can include program code configured to determine which one of multiple RPC frameworks 124a-b to use to process RPC-related communication from the client device 100. In other embodiments, the framework selection code 150 can be a standalone application executing within memory 102 of the server device 120.

Before establishing an MS-RPC session, the client device 100 can transmit one or more signals over the network 115 to establish a TCP/IP communication session with the server device 120. The established TCP/IP communication session is depicted by TCP session 108a in the client device 100 and TCP session 108b in the server device 120. The client device 100 can then transmit one or more signals over the network 115 to establish a CIFS/SMB connection. The established CIFS/SMB connection is depicted as CIFS session 106a, 106b.

The CIFS/SMB architecture of the server device 120 includes one or more SMB pipe(s) 128a-b. The SMB pipe(s) 128a-b can be represented as files in the file system for the server device 120. For example, common SMB pipes can include the files \samr for user management functions and \srvsvc for server management functions. Each SMB pipe 128a-b can provide access to one or more RPC suites 126. For example, SMB pipe 128a can provide access to RPC suites 126a-b and SMB pipe 128b can provide access to RPC suites 126c-d. Each RPC suite 126a-d is associated with an identifier (also referred to as a context ID) that identifies the RPC suite. Once a CIFS session 106a, 106b is established, the client device 100 can transmit one or more signals to the server device 120 for opening one of the SMB pipe(s) 128a-b. The client device 100 can also transmit one or more signals to the server device 120 to request binding to a particular RPC suite 126a-d by specifying the identifier for the RPC suite 126.

The server device 120 is configured to include multiple RPC frameworks 124a-b for processing and decoding RPC-related messages from the client device 100. For example, the RPC frameworks 124 can each define the management and negotiation of the bind operation between the client device 100 and the server device 120. The RPC frameworks 124 can also each define how to decode incoming network packets that carry RPC messages into the specific RPC function signatures that indicate the function or procedure call and input parameters that will be provided to the operating system 122. The RPC frameworks 124 can also each define how to encode outgoing RPC messages for transmission to client device 100. The server device 120 can also include a configuration file 130 in the memory device 102. The configuration file 130 can include information indicating which RPC framework to use for processing and decoding incoming and outgoing RPC messages. For example, the configuration file 130 can include a database, such as a two-dimensional array or a hash table, which associates an identification parameter to each RPC framework 124a-b. For example, the configuration file 130 can include information associating each SMB pipe 128a-b to a particular RPC framework 124a-b. Alternatively, the configuration file 130 can include information associating each RPC suite 126a-d to a particular RPC framework 124a-b (e.g., each RPC suite 126a-d can be identified and associated with an RPC framework 124 using respective context identifiers). In other embodiments, the configuration file 130 can include information associating a particular client identifier to an RPC framework 124a-b.

In the embodiment depicted in FIG. 1, RPC messages are filtered based on the SMB pipe 128a-b that is opened by the client device 100. The framework selection code 150 can be configured to monitor for an SMB pipe open request from the client device 100. Upon receiving an SMB pipe open request, the framework selection code 150 can be configured to check the configuration file 130 to determine which RPC framework 124a-b to select. In this example, configuration file 130 can include information indicating that all RPC messages carried on SMB pipe 128a are to be processed by RPC framework 124a and that all RPC messages carried on SMB pipe 128b are to be processed by RPC framework 124b. Thus, after the SMB pipe open procedure, the framework selection code 150 can route any CIFS/SMB communication received from the client device via the opened SMB pipe to the appropriate RPC framework 124.

As mentioned above, each SMB pipe 128a-b provides access to a set of RPC suites 126a-b or RPC suites 126c-d, respectively. Once an SMB pipe 128 is open, the client device 100 can transmit one or more signals for binding to an RPC suite 126 by providing the context identifier associated with the RPC suite 126. For example, the server device 120 can receive signals from the client device 100 identifying RPC suite 126a for binding to RPC suite 126a. The framework selection code 150 can be configured to monitor for requests to bind to a particular RPC suite 126. As explained above, SMB pipe 128a provides access to RPC suites 126a-b and SMB pipe 128b provides access to RPC suites 126c-d. The framework selection code 150 can identify a bind request to RPC suites 126a or 126b as being received via SMB pipe 128a. Thus, as the framework selection code 150 selected RPC framework 124a during the opening of SMB pipe 128a, the framework selection code 150 can route the bind requests to RPC suites 126a or 126b to RPC framework 124a. Similarly, the framework selection code 150 can identify a bind request to RPC suites 126c or 126d as being received via SMB pipe 128b. Thus, as the framework selection code 150 selected RPC framework 124b during the opening of SMB pipe 128b, the framework selection code 150 can route the bind requests to RPC framework 124b. The RPC framework 124 can then manage the bind operation of the relevant RPC suite 126.

Once bound to an RPC suite, client device 100 can transmit RPC commands/messages/requests (hereinafter referred to as “RPC messages”) to the operating system 122 executing in server device 120. Each RPC suite 126 can provide access to a different set of RPC messages. Each RPC message includes an OpNum identifier that identifies the particular function or procedure for execution in the operating system 122. If either RPC suites 126a or 126b (which are associated with SMB pipe 128a) provide access to the received RPC message, then the received RPC message is processed using RPC framework 124a. If either RPC suites 126c or 126d (which are associated with SMB pipe 128b) provide access to the received RPC message, then the received RPC message is processed using RPC framework 124b. The procedure or function identified by the OpNum identifier can then be executed in the operating system 122.

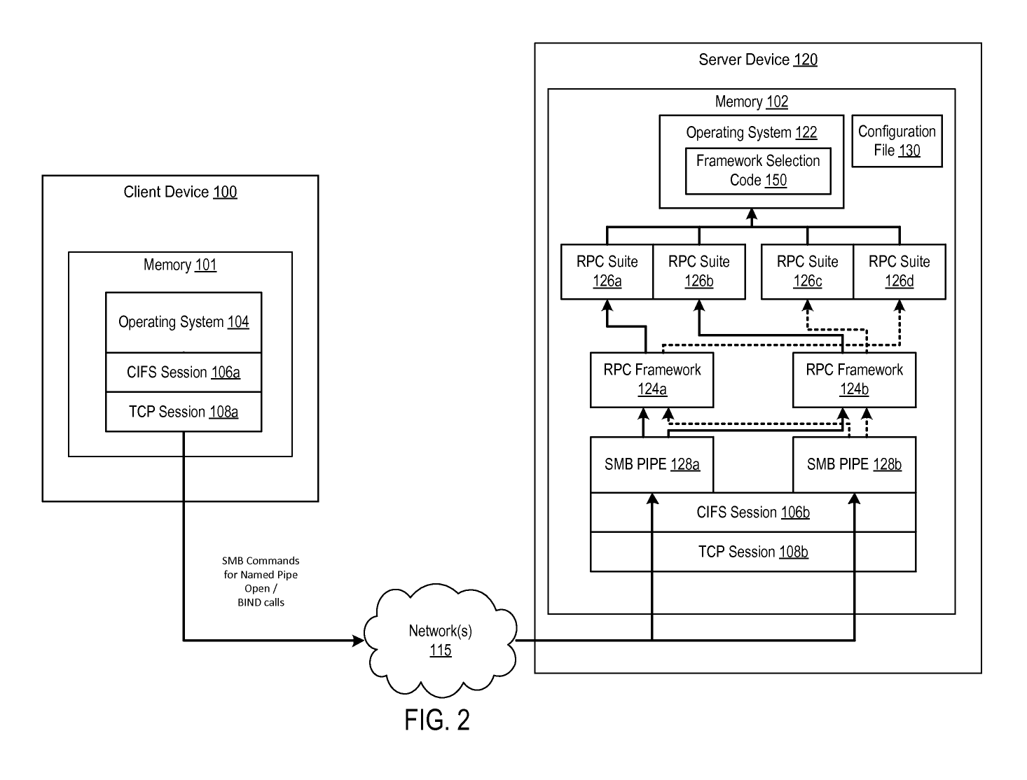

FIG. 2 depicts a similar client/server system as shown in FIG. 1, but in the example of FIG. 2 RPC messages are filtered to the appropriate RPC framework based on the RPC suite associated with the received RPC message. FIG. 2. includes client device 100 and server device 120 communicating via a network 115. Similar to FIG. 1, the client device 100 and server device 120 have an established TCP/IP session (shown as TCP sessions 108a-b) and a CIFS/SMB session (shown as CIFS sessions 106a-b). The operating system 104 in client device 100 can transmit RPC messages for execution by operating system 122 executing in the memory 102 of the server device 120. Once the CIFS session 106 is established, the client device 100 can open an SMB pipe 128a or 128b. Similar to FIG. 1, SMB pipe 128a provides access to RPC suites 126a-b (as shown via the solid lines in FIG. 2) and SMB pipe 128b provides access to RPC suites 126c-d (as shown by the dotted arrows in FIG. 2). A framework selection code 150 executing in the memory 102 of the server device 120 can monitor for incoming RPC-related communication and determine which one of multiple RPC frameworks 124 a-b to use to process RPC-related communication from the client device 100.

In the example depicted in FIG. 2, certain RPC messages associated with RPC suites 126a and 126d are supported by RPC framework 124a, but are not supported by RPC framework 124b. Likewise, certain RPC messages associated with RPC suites 126b and 126c are supported by RPC framework 124b, but are not supported by RPC framework 124a. For example, the complete encoding and decoding schemes for RPC suites 126a and 126d may be defined by RPC framework 124a, while the complete encoding and decoding schemes for RPC suites 126b and 126c may be defined by RPC framework 124b. In this example, the framework selection code 150 monitors for incoming bind requests from the client device 100. In response to receiving a bind request for a particular RPC suite 126 from the client device 100 (e.g., by receiving the context identifier for the particular RPC suite 126), regardless of which SMB pipe 128 is opened, the framework selection code 150 determines the appropriate RPC framework 124 to use to process the bind request and process subsequent RPC messages from the client device 100. Information associating RPC suites 126a-d to the appropriate RPC framework 124a or 124b can be included in the configuration file 130 as discussed above.

Once the client device 100 is bound to a particular RPC suite 126, the server device processes subsequent RPC messages associated with the bound RPC suite 126 using the RPC framework 124 determined using the configuration file 130. For example, RPC messages made available by RPC suite 126a and RPC messages made available by RPC suite 126d are decoded by RPC framework 124a. Similarly, RPC messages made available by RPC suite 126b and RPC messages made available by RPC suite 126c are decoded by RPC framework 124b. The RPC messages decoded and processed by the appropriate RPC framework 124 are passed as function or procedure calls or requests to operating system 122.

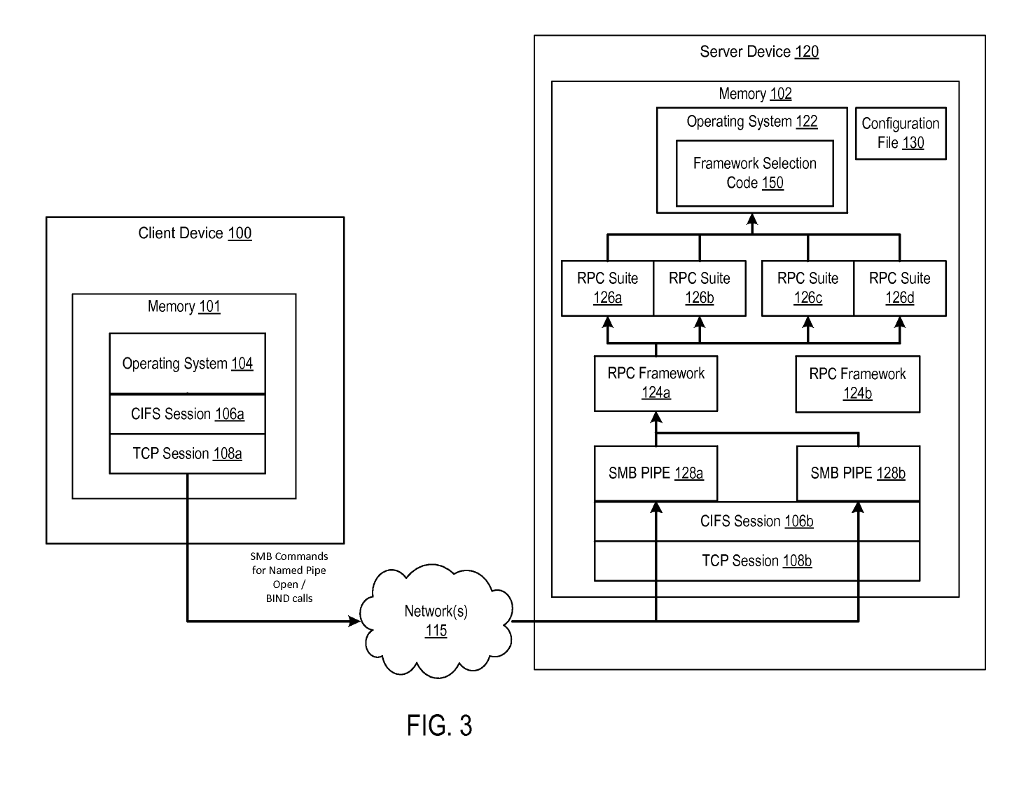

In some aspects, RPC messages can be filtered to the appropriate RPC framework based on a client identifier. FIG. 3 depicts the client/server system also illustrated in FIG. 1 and FIG. 2 but with all RPC suites 126a-d being decoded by the single RPC framework 124a. Similar to FIGS. 1 and 2, the client device 100 and server device 120 in FIG. 3 may communicate over network 115 to establish a TCP/IP session (shown as TCP sessions 108a-b) and a CIFS/SMB communication session (shown as CIFS sessions 106a-b). The client device 100 can be associated with a client identifier. The client identifier can be any identifier unique to the client device 100. For example, the client identifier can include the network IP address for the client device 100, Ethernet MAC address, or other identifier. The RPC infrastructure between the client device 100 and server device 120 can be set so that any RPC communication from the client device 100 is processed by a particular RPC framework (in this case, RPC framework 124a).

The configuration file 130 can include information associating the client identifier for client device 100 to RPC framework 124a. Similarly, the configuration file 130 can also include information associating a second client identifier for a second client device (not shown) to RPC framework 124b. The framework selection code 150 executing in the memory 102 of the server device 150, upon receiving communication from the client device 100, can select the appropriate RPC framework 124 to process bind requests and subsequent RPC messages from the client device 100 by referring to the configuration file 130. Thus, this aspect allows the server device 120 to receive and process RPC requests and messages from multiple client devices, with messages from each client device handled by a different RPC framework 124.

As in FIGS. 1 and 2, FIG. 3 depicts server device 120 with SMB pipes 128a-b. SMB pipe 128a provides access to RPC suites 126a-b and SMB pipe 126b provides access to RPC suites 126c-d. The server device 120 also includes RPC frameworks 124a-b. In this example, any RPC messages from client device 100 are processed by RPC framework 124a. A bind request from the client device 100 for binding to one of RPC suites 126a-d is processed and decoded by RPC framework 124a. Subsequent RPC messages on the bound RPC suite 126 are also processed and decoded by RPC framework 124a. The processed and decoded RPC messages are provided to operating system 122 for execution.

While FIGS. 1-3 are depicted as examples of client/server communication systems employing MS-RPC, other embodiments involve servers configured for selecting between multiple RPC frameworks for client/server communication via standard RPC over TCP/IP. In standard RPC over TCP/IP, the client/server do not establish a CIFS session 106 or open SMB pipes 128a-b. Instead, after establishing a TCP/IP connection, the server device 120 can receive communication from the client device 100 for binding to an RPC suite 126a-d. In such embodiments, the server device 120 can be configured to determine which RPC framework 124 to use for processing and decoding RPC messages during the bind operation.

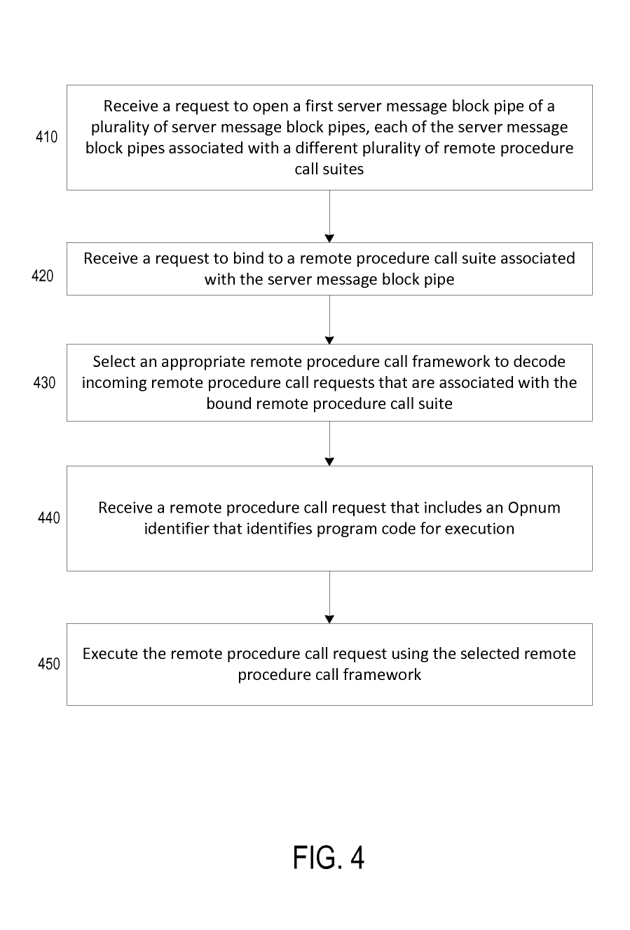

FIG. 4 is a flowchart illustrating an example of a method 400 performed by a service device for selecting between multiple RPC frameworks in a MS-RPC architecture. For illustrative purposes, the method 400 is described with reference to the system implementations depicted in FIGS. 1-3. Other implementations, however, are possible.

The method 400 involves receiving a request to open a first SMB pipe of a plurality of SMB pipes, where each of the SMB pipes is associated with a set of RPC suites, as shown in block 410. For example, after establishing a CIFS session 106, the server device 120 can receive communication from the client device 100 for opening one of the SMB pipes 128a-b. The communication from the client device 100 can include the name of the SMB pipe 128, which can be represented as a file in the file system of the server device 120. Each SMB pipe 128a-b can provide access to a set of RPC suites. For example, SMB pipe 128a can provide access to RPC suites 126a-b and SMB pipe 128b can provide access to RPC suites 126c-d, as depicted in FIG. 1. As another example, SMB pipe 128a can provide access to RPC suites 126a-d and SMB pipe 128b can provide access to RPC suites 126a-d, as depicted in FIG. 2.

The method 400 further involves receiving a request to bind to a RPC suite associated with the SMB pipe, as shown in block 420. For example, the server device 120 can receive communication from the client device 100 that includes a context identifier identifying one of the RPC suites 126a-d. The identified RPC suite 126 can expose one or more RPC procedures capable of execution in the operating system 122. Once bound to one of the RPC suites 126, the server device 120 can receive RPC messages for executing the associated RPC procedures.

The method 400 further involves determining an appropriate RPC framework to decode incoming RPC messages/requests that are associated with the bound RPC suite, as shown in block 430. For example server device 120 can include multiple RPC frameworks 124 in memory 102. Each RPC framework 124 can include the program code that defines how to encode RPC related communication from the client device 100. The server device 120 can determine the appropriate RPC framework 124 to decode incoming RPC communication by accessing information stored in a configuration file 130 in memory 102. As discussed above with reference to FIG. 1, the configuration file 130 can be a database in the form of a data structure in memory, such as a hash table or two dimensional array. Alternatively, the configuration file 130 can refer to a parameter in program code in an executing operating system, such as operating system 122. The configuration file 130 can specify the appropriate RPC framework 124 to use depending on a variety of factors.

In one example, the appropriate remote RPC framework 124 can be determined based on the particular opened SMB pipe 128. In this aspect, all RPC related communication and RPC procedure call requests associated with any of the RPC suites 126 associated with the opened SMB pipe 128 are decoded by the selected RPC framework 124. For example, during the opening of SMB pipe 128a, the framework selection code 150 executing in the memory 102 of server device 120 can determine that any subsequent bind operation to RPC suites 126a-b is to be decoded by RPC framework 124a. Any RPC messages that are made available by RPC suites 126a-b are thus also decoded and processed by RPC framework 124a.

In another example, the appropriate RPC framework 124 can be determined based on the particular RPC suite 126 to which the client device is bound. In this aspect, all RPC related communication and RPC procedure call requests associated with the bound RPC suite 126 are decoded by the selected RPC framework 124. For example, during the bind operation to RPC suite 126b, the server device 120 can receive a context identifier identifying RPC suite 126b. Through information specified in configuration file 130, the framework selection code 150 executing in the memory 102 of server device 120 can determine that the bind operation should be decoded and processed by RPC framework 124b. Any RPC messages that are made available by RPC suite 126b are thus also decoded and processed by RPC framework 124b the RPC framework 124 is determined by a client identifier of the client device 100. In this aspect, all subsequent RPC requests and communication from the client device 100 are decoded by the selected RPC framework 124. For example, through identifying information specified in and/or provided by the client device 130, the framework selection code 150 can determine that RPC bind requests and subsequent RPC messages from client device 100 should be decoded by RPC framework 124a. In this aspect, the appropriate RPC framework 124 can be determined by the framework selection code 150 during establishment of the TCP/IP session, CIFS session, the opening of the SMB pipe, or binding of the RPC suite.

The method 400 further involves receiving an RPC request/message that includes an OpNum identifier that identifies program code for execution, as shown in block 440. For example, after receiving a request to bind to a particular RPC suite 126, the server device 120 may receive communication carrying an RPC message from the client device 100 that includes an OpNum identifier. The OpNum identifier specifies the function call or other program code to execute as part of the operating system 122 running in the server device 120.

The method 400 further involves executing the RPC request/message using the selected RPC framework, as shown in block 450. For example, the server device 120 uses the RPC framework 124 determined in step 430 to decode and process the received RPC message. The decoded RPC message is provided to the operating system 122, which executes the relevant function call as specified by the OpNum identifier with any inputs provided from client device 100. Alternatively, the RPC message may include a query requesting information to return from the server device 120. The operating system 122 can execute program code and return a value in response to the query. The server device 120 can provide any response to the RPC message back to the client device 100 by encoding a return RPC message using the RPC framework selected in step 430 and transmitting the return RPC message using the CIFS/SMB connection over TCP/IP.

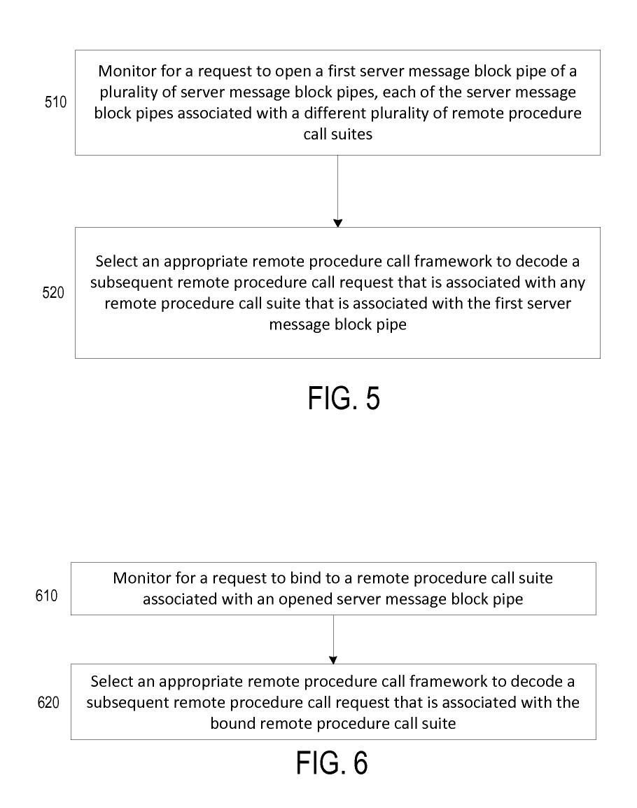

In some embodiments, the functionality of monitoring for incoming communication from the client device 100 and selecting appropriate RPC frameworks 124 based on information in the configuration file 130 can be performed by execution of program code in the memory 102 of server device 120. As discussed above, the framework selection code 150 can include a software module that executes program code to perform this functionality. FIGS. 5-7 are flowcharts depicting example processes that the framework selection code 150 can execute to perform the functionality of certain embodiments herein.

FIG. 5 is a flowchart depicting an example process 500 that the framework selection code 150 can execute to select an RPC framework 124 based on a request for an SMB pipe 128, as discussed above with respect to FIGS. 1 and 4. The process 500 includes monitoring for a request to open a first SMB pipe of a plurality of SMB pipes, each SMB pipe associated with a different set of RPC suites, as shown in block 510. For example, the framework selection code 150 can monitor for requests from the client device 100 to open an SMB pipe 128. Details of the SMB pipe 128 and the request to open the SMB pipe 128 are provided above in the discussion with respect to FIGS. 1 and 4. The process 500 further includes selecting an appropriate RPC framework to decode a subsequent RPC request that is associated with any RPC suite that is associated with the first SMB pipe, as shown in block 520. For example, the framework selection code 150 can access the configuration file 130 to select the appropriate RPC framework 124. As discussed above with respect to FIGS. 1 and 4, the configuration file 130 can include information respectively associating RPC frameworks 124a-b to different sets of RPC suites 126.

FIG. 6 is a flowchart depicting an example process 600 that the framework selection code 150 can execute to select an RPC framework 124 based on a request to bind to an RPC suite 126, as discussed above with respect to FIGS. 2 and 4. The process 600 includes monitoring for a request to bind to an RPC suite 126 associated with an opened SMB pipe 128, as shown in block 610. For example, the framework selection code 150 can monitor for requests from the client device 100 to bind to a specific RPC suite 126 associated with an open SMB pipe 128. Details of the request to bind to an RPC suite 126 are provided above in the discussion with respect to FIGS. 2 and 4. The process 600 further includes selecting an appropriate RPC framework to decode a subsequent RPC request that is associated with the bound RPC suite, as shown in block 620. For example, the framework selection code 150 can access the configuration file 130 to select the appropriate RPC framework 124. The configuration file 130 can include information respectively associating RPC frameworks 124a-b to different sets of RPC suites 126.

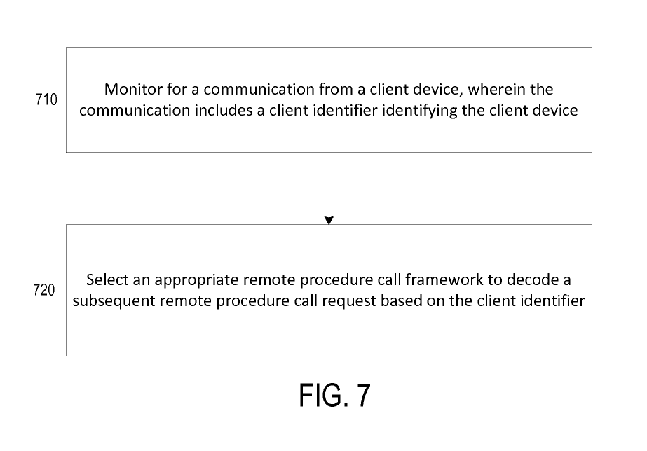

FIG. 7 is a flowchart depicting an example process 700 that the framework selection code 150 can execute to select an RPC framework 124 based on a client identifier, as discussed above with respect to FIGS. 3 and 4. The process 700 includes monitoring for a communication from a client device, wherein the communication includes a client identifier identifying the client device. For example, the framework selection code 150 can monitor for requests from the client device 100 for establishing a TCP session 108 or a CIFS session 106. The request from the client device can include a client identifier such as an IP address, MAC address, or other identifier. The process further includes selecting an appropriate RPC framework to decode a subsequent RPC request based on the client identifier, as shown in block 720. For example, the framework selection code 150 can access the configuration file 130 to select the appropriate RPC framework 124. The configuration file 130 can include information associating RPC frameworks 124a-b to respective client identifiers.

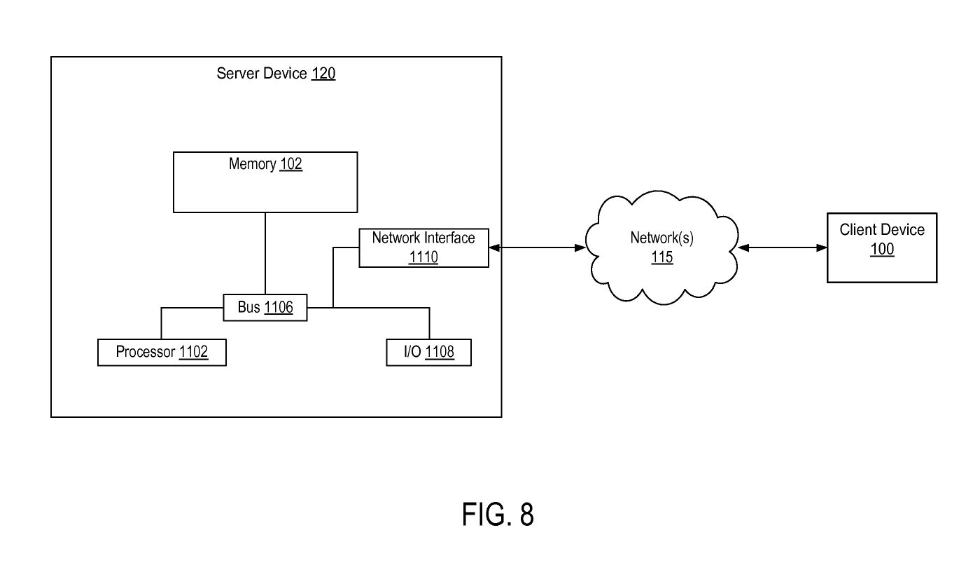

Any suitable computing system or groups of computing systems can be used to implement the server device 120 and the client device 100. FIG. 8 is a block diagram depicting an example of a server device 120 communicating over a network 115 with a client device 100 over a TCP/IP session. FIG. 8 also depicts additional hardware components of the server device 120 for executing the processes described herein. Persons skilled in the art would understand that the client device 100 includes similar hardware components that provide similar functionality.

The server device 120 can include a processor 1102 that is communicatively coupled to a memory 102 and that executes computer-executable program code and/or accesses information stored in the memory 102. For example, as shown in FIGS. 1-3, the memory 102 can include instructions for executing program operating system 122. The memory 102 can also store the configuration file 130 that provides information regarding which RPC framework to use for processing incoming RPC requests from the client device 100. The memory 102 can also include program code for enabling the RPC architecture that includes the set of RPC suites 126a-d. Further, the memory 102 can include multiple RPC frameworks 124a-b that define the encoding/decoding schemes for each RPC suite 126. The memory 102 can also include program code for enabling the CIFS/SMB architecture. For example, the memory 102 can include pseudo-files as part of the file system of the server device 120 that indicate the names of the SMB named pipes 128a-b.

The processor 1102 may comprise a microprocessor, an application-specific integrated circuit (“ASIC”), a state machine, or other processing device. The processor 1102 can include any of a number of processing devices, including one. Such a processor 1102 can include or may be in communication with a computer-readable medium (e.g. memory 102) storing instructions that, when executed by the processor 1102, cause the processor to perform the operations described herein for selecting an RPC framework 124 for processing RPC messages.

The memory 102 can be or include any suitable non-transitory computer-readable medium. The computer-readable medium can include any electronic, optical, magnetic, or other storage device capable of providing a processor with computer-readable instructions or other program code. Non-limiting examples of a computer-readable medium include a floppy disk, CD-ROM, DVD, magnetic disk, memory chip, ROM, RAM, an ASIC, a configured processor, optical storage, magnetic tape or other magnetic storage, or any other medium from which a computer processor can read instructions. The program code or instructions may include processor-specific instructions generated by a compiler and/or an interpreter from code written in any suitable computer-programming language, including, for example, C, C++, C#, Visual Basic, Java, Python, Perl, JavaScript, and ActionScript. The server device 120 can execute program code that configures the processor 1102 to perform one or more of the operations described above with respect to FIGS. 1-4.

The server device 120 may also comprise a number of external or internal devices such as input or output devices. For example, the server device 120 is shown with an input/output (“I/O”) interface 1108 that can receive input from input devices or provide output to output devices. A bus 1106 can also be included in the server device 120. The bus 1106 can communicatively couple one or more components of the server device 120.

The server device 120 can also include at least one network interface 1110. The network interface 1110 can include any device or group of devices suitable for establishing a wired or wireless data connection to one or more data networks 115. Non-limiting examples of the network interface 1110 include an Ethernet network adapter, a modem, and/or the like to establish a TCP/IP connection with the client device 100. The server device 120 can communicate the client device 100 using the network interface 1110. Those skilled in the art will appreciate that a typical server device 120 will include hardware and software components other than those shown in FIGS. 1-3 and 5, which were provided by way of example only and not by way of limitation.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

Some embodiments described herein may be conveniently implemented using a conventional general purpose or a specialized digital computer or microprocessor programmed according to the teachings herein, as will be apparent to those skilled in the computer art. Some embodiments may be implemented by a general purpose computer programmed to perform method or process steps described herein. Such programming may produce a new machine or special purpose computer for performing particular method or process steps and functions (described herein) pursuant to instructions from program software. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art will understand that information may be represented using any of a variety of different technologies and techniques.

Some embodiments include a computer program product comprising a computer readable medium (media) having instructions stored thereon/in that, when executed (e.g., by a processor), cause the executing device to perform the methods, techniques, or embodiments described herein, the computer readable medium comprising instructions for performing various steps of the methods, techniques, or embodiments described herein. The computer readable medium may comprise a non-transitory computer readable medium. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

The various illustrative logical blocks, modules, and circuits described in connection with the embodiments disclosed herein may be implemented or performed with a general-purpose processing device, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processing device may be a microprocessor, but in the alternative, the processor may be any conventional processor, controller, microcontroller, or state machine. A processing device may also be implemented as a combination of computing devices, e.g., a combination of a DSP and a microprocessor, a plurality of microprocessors, one or more microprocessors in conjunction with a DSP core, or any other such configuration

Aspects of the methods disclosed herein may be performed in the operation of such processing devices. The order of the blocks presented in the figures described above can be varied—for example, some of the blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation and are not meant to be limiting.

While the present subject matter has been described in detail with respect to specific examples thereof, it will be appreciated that those skilled in the art, upon attaining an understanding of the foregoing may readily produce alterations to, variations of, and equivalents to such aspects and examples. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method, comprising:
receiving, at a server device, a request from a client device to open a first server message block pipe of a plurality of server message block pipes, each of the server message block pipes associated with a plurality of remote procedure call suites;
receiving, at the server device, a request from the client device to bind to a first remote procedure call suite from the plurality of remote procedure call suites associated with the server message block pipe;
selecting, by the server device, an appropriate remote procedure call framework of a plurality of remote procedure call frameworks to decode incoming remote procedure call requests that are associated with the first remote procedure call suite;
receiving, at the server device, a remote procedure call request from a client device for execution of program code at the server device, wherein the remote procedure call request identifies the program code for execution, and wherein the remote procedure call request is associated with the first remote procedure call suite; and
executing the remote procedure call request using the selected remote procedure call framework.

2. The method of claim 1, wherein each of the server message block pipes is associated with a plurality of different remote procedure call suites; and
wherein the selected remote procedure call framework is selected based on an association with the first server message block pipe, wherein all subsequent remote procedure call requests associated with any of the plurality of remote procedure call suites associated with the first server message block pipe are decoded by the selected remote procedure call framework.

3. The method of claim 2, wherein the selected remote procedure call framework is selected using information stored in a configuration file in the server device, wherein the information in the configuration file indicates an association of the first server message block pipe with the selected remote procedure call framework, and wherein the configuration file includes additional information associating a second server message block pipe to a different remote procedure call framework.

4. The method of claim 1, wherein the selected remote procedure call framework is selected based on an association with the first remote procedure call suite, wherein all subsequent remote procedure call requests associated with the first remote procedure call suite are decoded by the selected remote procedure call framework.

5. The method of claim 4, wherein the selected remote procedure call framework is selected using information stored in a configuration file in the server device, wherein the information in the configuration file indicates an association of the first remote procedure call suite to the selected remote procedure call framework, and wherein the configuration file further includes information associating a second remote procedure call suite to a different remote procedure call framework.

6. The method of claim 1, wherein the selected remote procedure call framework is selected using information stored in a configuration file in the server device, wherein the configuration file includes information associating an client identifier of the client device to the selected remote procedure call framework, and wherein all subsequent remote procedure call requests from the client device are decoded by the selected remote procedure call framework.

7. The method of claim 6, further comprising:
receiving a second remote procedure call request from a second client device, the second client device having a second client identifier;
determining a second remote procedure call framework of the plurality of remote procedure call frameworks to decode the incoming remote procedure call request from the second client device that are associated with the first remote procedure call suite, wherein the second remote procedure call framework is determined by using information stored in the configuration file, and wherein the configuration file includes information associating the second client identifier to the second remote procedure call framework; and
executing a second remote procedure call request from the second client device using the second remote procedure call framework.

8. A server device, comprising:
a processor device; and
a memory device including program code stored thereon, wherein the program code, upon execution by the processor device, performs operations comprising:
receiving a request from a client device to open a first server message block pipe of a plurality of server message block pipes, each of the server message block pipes associated with a plurality of remote procedure call suites;
receiving a request from the client device to bind to a first remote procedure call suite from the plurality of remote procedure call suites associated with the server message block pipe;
selecting an appropriate remote procedure call framework of a plurality of remote procedure call frameworks to decode incoming remote procedure call requests that are associated with the first remote procedure call suite;
receiving a remote procedure call request from a client device for execution of program code at the server device, wherein the remote procedure call request identifies the program code for execution, and wherein the remote procedure call request is associated with the first remote procedure call suite; and
executing the remote procedure call request using the selected remote procedure call framework.

9. The server device of claim 8, wherein each of the server message block pipes is associated with a plurality of different remote procedure call suites; and
wherein the selected remote procedure call framework is selected based on an association with the first server message block pipe, wherein all subsequent remote procedure call requests associated with any of the plurality of remote procedure call suites associated with the first remote message block pipe are decoded by the selected remote procedure call framework.

10. The server device of claim 9, wherein the selected remote procedure call framework is selected using information stored in a configuration file in the server device, wherein the information in the configuration file indicates an association of the first server message block pipe with the selected remote procedure call framework, and wherein the configuration file includes additional information associating a second server message block pipe to a different remote procedure call framework.

11. The server device of claim 8, wherein the selected remote procedure call framework is selected based on an association with the first remote procedure call suite, wherein all subsequent remote procedure call requests associated with the first remote procedure call suite are decoded by the selected remote procedure call framework.

12. The server device of claim 11, wherein the selected remote procedure call framework is selected using information stored in a configuration file in the memory device, wherein the information in the configuration file indicates an association of the first remote procedure call suite to the selected remote procedure call framework, and wherein the configuration file further includes information associating a second remote procedure call suite to a different remote procedure call framework.

13. The server device of claim 8, wherein the selected remote procedure call framework is selected using information stored in a configuration file in the memory device, wherein the configuration file includes information associating an identifier of the client device to the selected remote procedure call framework, and wherein all subsequent remote procedure call requests from the client device are decoded by the appropriate remote procedure call framework.

14. The server device of claim 8, wherein the memory device further includes program code that, upon execution by the processor device, performs operations comprising:
selecting a second remote procedure call framework of the plurality of remote procedure call frameworks to decode additional remote procedure call requests that are associated with the first remote procedure call suite, wherein the second remote procedure call framework is determined by using information stored in the configuration file, and wherein the configuration file includes information associating a second client identifier to the second remote procedure call framework, the second client identifier associated with a second client device.

15. A non-transitory computer-readable medium having program code stored thereon, wherein, upon execution, the program code performs operations comprising:
receiving a request from a client device to open a first server message block pipe of a plurality of server message block pipes, each of the server message block pipes associated with a plurality of remote procedure call suites;
receiving a request from the client device to bind to a first remote procedure call suite from the plurality of remote procedure call suites associated with the server message block pipe;
selecting an appropriate remote procedure call framework of a plurality of remote procedure call frameworks to decode incoming remote procedure call requests that are associated with the first remote procedure call suite;
receiving a remote procedure call request from a client device for execution of program code at the server device, wherein the remote procedure call request identifies the program code for execution, and wherein the remote procedure call request is associated with the first remote procedure call suite; and
executing the remote procedure call request using the selected remote procedure call framework.

16. The non-transitory computer-readable medium of claim 15, wherein each of the server message block pipes is associated with a plurality of different remote procedure call suites; and
wherein the selected remote procedure call framework is selected based on an association with the first server message block pipe, wherein all subsequent remote procedure call requests associated with any of the plurality of remote procedure call suites associated with the first server message block pipe are decoded by the selected remote procedure call framework.

17. The non-transitory computer-readable medium of claim 16, wherein the selected remote procedure call framework is selected using information stored in a configuration file in the server device, wherein the information in the configuration file indicates an association of the first server message block pipe with the selected remote procedure call framework, and wherein the configuration file includes additional information associating a second server message block pipe to a different remote procedure call framework.

18. The non-transitory computer-readable medium of claim 15, wherein the selected remote procedure call framework is selected based on an association with the first remote procedure call suite, wherein all subsequent remote procedure call requests associated with the first remote procedure call suite are decoded by the selected remote procedure call framework.

19. The non-transitory computer-readable medium of claim 18, wherein the selected remote procedure call framework is selected using information stored in a configuration file in the memory device, wherein the information in the configuration file indicates an association of the first remote procedure call suite to the selected remote procedure call framework, and wherein the configuration file further includes information associating a second remote procedure call suite to a different remote procedure call framework.

20. The non-transitory computer-readable medium of claim 15, wherein the selected remote procedure call framework is selected using information stored in a configuration file in the memory device, wherein the configuration file includes information associating an identifier of the client device to the selected remote procedure call framework, and wherein all subsequent remote procedure call requests from the client device are decoded by the appropriate remote procedure call framework.
